(19) United States
(12) Patent Application Publication
(10) Pub. No.: US 2025/0086358 A1
(43) Pub. Date: Mar. 13, 2025

(54) OPTICAL CRITICAL DIMENSION METROLOGY AIDED BY DEEP LEARNING

(71) Applicant: GOOGLE LLC, Mountain View, CA (US)

(72) Inventor: Eric Yi Zhu, Toronto (CA)

(21) Appl. No.: 18/367,231

(22) Filed: Sep. 12, 2023

(51) Int. Cl. G06F 30/27; G01M 11/00

(52) U.S. Cl. CPC G06F 30/27; G01M 11/37; G02B 27/0172; G06F 2119/18

(57) ABSTRACT

A computer-implemented method in a processing device of an Optical Critical Dimension (OCD) metrology system includes receiving grating parameters as input to a neural network. The neural network generates an output including a predicted optical response of a grating based on the grating parameters. Responsive to determining that a difference between the predicted optical response and a measured optical response of the grating is within a specified threshold, the grating parameters are output as a predicted structure of the grating. Responsive to determining that the difference is greater than the specified threshold, the grating parameters received as input to the neural network are iteratively updated until the predicted optical response and the measured optical response converge.

### BACKGROUND

Periodic nanostructures (herein referred to as “gratings”) are critical components in various photonic and optoelectronic devices, including near-to-eye display (NED) devices (e.g., augmented reality glasses, mixed reality glasses, virtual reality headsets, other head-mounted displays (HMDs), and the like), computer memory technology such as NAND flash memory and dynamic random access memory (DRAM), telecommunication systems, sensors, spectrometers, and photonic integrated circuits. For example, NED devices are wearable electronic devices that combine real-world and virtual images via one or more waveguides to provide a virtual display that is viewable by a user when the wearable display device is worn on the head of the user. NED devices implement waveguides (also termed a lightguide), such as one or more integrated combiner lenses, to transfer light. In general, light from a projector of the wearable display device enters the waveguide of the optical combiner through a first grating, such as an incoupler, propagates within the waveguide, and exits the waveguide through a second grating, such as an outcoupler. If the pupil of the eye is aligned with one or more exit pupils provided by the second grating, at least a portion of the light exiting through the second grating will enter the pupil of the eye, thereby enabling the user to see a virtual image. Since the combiner lens is transparent, the user will also be able to see the real world.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating an example Optical Critical Dimension (OCD) metrology system for identifying a structure of an optical grating in accordance with some embodiments.

FIG. 2 is a diagram illustrating an example hardware configuration of a processing device of the OCD metrology system of FIG. 1 in accordance with some embodiments.

FIG. 3 is a diagram illustrating an example hardware configuration of a neural network managing device of the OCD metrology system of FIG. 1 in accordance with some embodiments.

FIG. 4 is a flow diagram illustrating an example method for training neural networks to predict the optical response of an optical grating 112 in accordance with some embodiments.

FIG. 5 is a diagram illustrating a machine learning (ML) module employing a neural network during the training process described above with respect to FIG. 4 in accordance with some embodiments.

FIG. 6 is a diagram illustrating the ML module of FIG. 5 employing a trained neural network to predict a structure of a grating in accordance with some embodiments.

FIG. 7 is a flow diagram illustrating an example method of the processing device of FIG. 1 using a trained neural network to predict the structure of a grating in accordance with some embodiments.

FIG. 8 is a diagram of waveguide, such as an augmented reality waveguide, including multiple gratings in accordance with some embodiments.

FIG. 9 is a diagram illustrating an example display system in accordance with some embodiments.

### SUMMARY OF EMBODIMENTS

In accordance with one aspect, a computer-implemented method in a processing device of an Optical Critical Dimension (OCD) metrology system includes receiving grating parameters as input to a neural network. The neural network generates an output including a predicted optical response of a grating based on the grating parameters. The grating parameters are output as a predicted structure of the grating responsive to determining that a difference between the predicted optical response and a measured optical response of the grating is within a specified threshold. Responsive to determining that the difference is greater than the specified threshold, the grating parameters received as input to the neural network are iteratively updated until the predicted optical response and the measured optical response converge.

In accordance with another aspect a computer-implemented method in a processing device of an Optical Critical Dimension (OCD) metrology system includes receiving a measured optical response of a grating. An initial guess for parameters of the grating is obtained randomly and input into a neural network. The neural network generates a predicted optical response based on the parameters. The predicted optical response and the measured optical response are compared. If a determination is made based on the comparison that the predicted optical response and the measured optical response are within a specified threshold, the parameters are output as a predicted structure of the grating. If a determination is made based on the comparison that the predicted optical response and the measured optical response are outside of a specified threshold, the parameters are updated iteratively until the predicted optical response and the measured optical response converge.

In accordance with a further aspect, a processing device includes a processor and a prediction module implemented at the processor. The prediction module implements a neural network and is configured by the processor to generate an output including a predicted optical response of a grating based on the grating parameters. The prediction module is also configured by the process to output the grating parameters as a predicted structure of the grating responsive to a determination that a difference between the predicted optical response and a measured optical response of the grating is within a specified threshold. The prediction module is further configured by the processor to, responsive to a determination that the difference is greater than the specified threshold, iteratively update the grating parameters received as input to the neural network until the predicted optical response and the measured optical response converge.

In accordance with another aspect, a near-eye display includes an image source to project light comprising an image, at least one lens element, and a waveguide. The waveguide includes at least one grating having a structure verified by the following process. Grating parameters are received as input to a neural network. The neural network generates an output including a predicted optical response of a grating based on the grating parameters. The grating parameters are output as a predicted structure of the grating responsive to determining that a difference between the predicted optical response and a measured optical response of the grating is within a specified threshold. Responsive to determining that the difference is greater than the specified threshold, the grating parameters received as input to the neural network are iteratively updated until the predicted optical response and the measured optical response converge.

### DETAILED DESCRIPTION

The incorporation of periodic nanostructures (also referred to herein as “gratings” or “grating structures”) into waveguides is critical to the performance of photonic and optoelectronic devices, such as NEDs, NAND memory, DRAM, and the like. The performance of a grating largely depends on its physical characteristics, such as dimensions, shapes, and profiles, including features such as grating period, grating depth, duty cycle, and sidewall angle. Precise manufacturing and quality control of gratings structures are crucial for the reliable operation of the devices that use them. However, conventional fabrication processes of gratings often result in structures that may deviate from their intended design, which causes improper functioning of the overall device.

Traditional techniques for determining the physical characteristics and identifying design deviations of gratings include scanning electron microscopy (SEM) and atomic force microscopy (AFM). These methods can be time-consuming, involve complex sample preparation procedures, or potentially damage the sample. Optical Critical Dimension (OCD) metrology has emerged as a powerful technique to non-destructively characterize structures on the nanoscale. By measuring the light scattered, reflected, or transmitted by a sample, OCD can provide information about the sample's dimensions and profile. However, this technique involves a complex process of matching the measured spectra with simulations based on a theoretical model of the grating. Also, accurately modeling and simulating the light interaction with complex gratings can be computationally intensive and time-consuming.

For example, simulating the light interaction in a grating typically involves calculating how incident light gets reflected, transmitted, or scattered by the structure based on its geometry and material properties. Gratings are complex in nature, as they often have multiple layers, each with different material properties, and can have small, intricate features, such as the repeating pattern in a grating. Also, the grating pattern can induce phenomena like diffraction and interference, further complicating the light-structure interaction. To accurately model and simulate these complex interactions, the simulation process typically needs to solve Maxwell's equations, which describe the behavior of electromagnetic fields. This usually involves the use of numerical methods, such as Finite-Difference Time-Domain (FDTD) or Rigorous Coupled-Wave Analysis (RCWA). These methods discretize the structure and the incident light into small elements and compute the electromagnetic field distribution.

The computations performed by the numerical methods are very complex and intensive. For example, the structure under consideration must be discretized into elements that are much smaller than the wavelength of light to capture the fine details of the structure and the electromagnetic field distribution. This discretization process results in a large number of elements and, hence, a large number of equations to solve. Also, to capture the spectral characteristics of the scattered light, the simulation needs to be performed for many different wavelengths, adding another dimension to the problem. The simulation also needs to account for different polarization states and angles of incidence of the light, which can lead to different scattering characteristics. Additionally, the simulation needs to be repeated each time the model parameters are adjusted in the OCD process, adding to the computational load. As a result, despite the power of modern computing systems, accurately modeling and simulating the light interaction with complex gratings can be computationally intensive and time-consuming, which is a significant challenge, particularly in a manufacturing context where rapid feedback is often needed.

Rather than implement compute-intensive and potentially time-intensive full-wave electromagnetic solvers, such as FDTD and RCWA, to perform regression and back-calculation during the OCD metrology process, the following describes example systems and techniques that utilize deep learning and automatic differentiation to increase OCD regression computation time by more than 2 orders of magnitude. Conventional full-wave electromagnetic solvers for OCD metrology processes are replaced by or supplemented by one or more individually trained or one or more pairs of jointly trained neural networks that operate to predict the optical response (e.g., the interaction of light with the gratings) of the gratings. The individually or jointly trained neural network architecture includes one or more neural networks, each of which is trained to, in effect, provide more accurate and efficient optical response predictions than conventional full-wave electromagnetic solvers. The fully differentiable nature of the neural network(s) is leveraged to perform regression for finding the maximum-likelihood grating structure. The systems and techniques described herein are able to accurately predict the structures of an assortment of grating types including, one-dimensional (1D) periodic, two-dimensional (2D)-periodic, and different material stacks (e.g., gratings etched into silicon, inorganic etched gratings, nanoimprinted organic resin-based gratings, or the like).

As described in greater detail below, one or more neural networks, such as a deep neural network(s) (DNNs), are trained to predict ellipsometric spectra or Mueller matrices derived from ellipsometric spectra for a particular type of grating. The grating structure is defined by a set of parameters, such as grating height, pitch, and fill factor. In at least some embodiments, training data is generated via full-wave simulations (such as RCWA, FDTD, or Discontinuous Galerkin Time-Domain (DGTD)) for varying grating parameters and illumination conditions (e.g., wavelength, angle of incidence, plane of incidence, and the like). By training the neural network(s) on this data, the neural network(s) is able to predict/infer the optical response of a grating given a set of inputs (e.g., grating constructional parameters, illumination conditions, and the like). The inference performed using the trained neural network(s) to generate simulated data (e.g., optical response) is at least one hundred times faster than processes implementing full-wave simulations. A maximum likelihood estimation of the grating structure is then performed by fitting the data simulated by the trained neural network model(s) to optical response data (e.g., ellipsometry data, Mueller matrices derived from ellipsometry data) measured by the OCD metrology system. In at least some embodiments, this process involves minimizing a cost function, such as a mean square error (MSE) function, with respect to the input parameters of the trained neural network model(s). Gradient-descent (first-order) or Hessian-based (second-order) techniques are used to determine the optimal fitting parameters. The output of the maximum likelihood estimation is a prediction of the grating structure including grating height, pitch, fill factor, and the like.

An advantage of the techniques described herein is that computing any function of the neural network and the gradient thereof involves only a single evaluation due to the automatic differentiability (autodiff) of the neural network. It should be understood that the terms “automatic differentiability” and “back-propagation” are used interchangeably throughout this description. Traditionally, it would take on the order of 2p evaluations of the MSE function to compute the gradient of a function having p parameters. As such, the techniques described herein, increase the speed at which grating structure back-calculation is performed during the OCD metrology process by another factor of p, which is on the order of 10. Stated differently, the techniques described herein speed up grating structure back-calculation by more than 3 orders of magnitude. As used herein, the term “back-calculation” refers to the process of solving the inverse problems by using a measured optical response to obtain the maximum-likelihood estimation of the grating parameters. Also, the ease with which the gradients of a neural network model are calculated using the techniques described herein also extends to higher-order derivatives. The evaluation of higher-order derivatives, such as the Hessian, allows the uncertainty for each back-calculated grating parameter to be understood and how those parameters are coupled to one another. Calculating the Hessian for a conventional model with p parameters would require an order of p² evaluations, whereas the deep learning model of one or more embodiments requires only a single evaluation. Therefore if a model has p=10 parameters, the techniques described herein result in an approximately 100-fold speed-up in calculating uncertainties and correlations in a model.

The techniques described herein, which combine OCD metrology with machine-learning-assisted grating structure back-calculation, can be deployed in various environments. For example, the techniques described herein can be implemented in manufacturing environments to provide fast feedback to process engineers and systems so that the fabrication process can be properly tuned and yield increased, which drives down manufacturing costs.

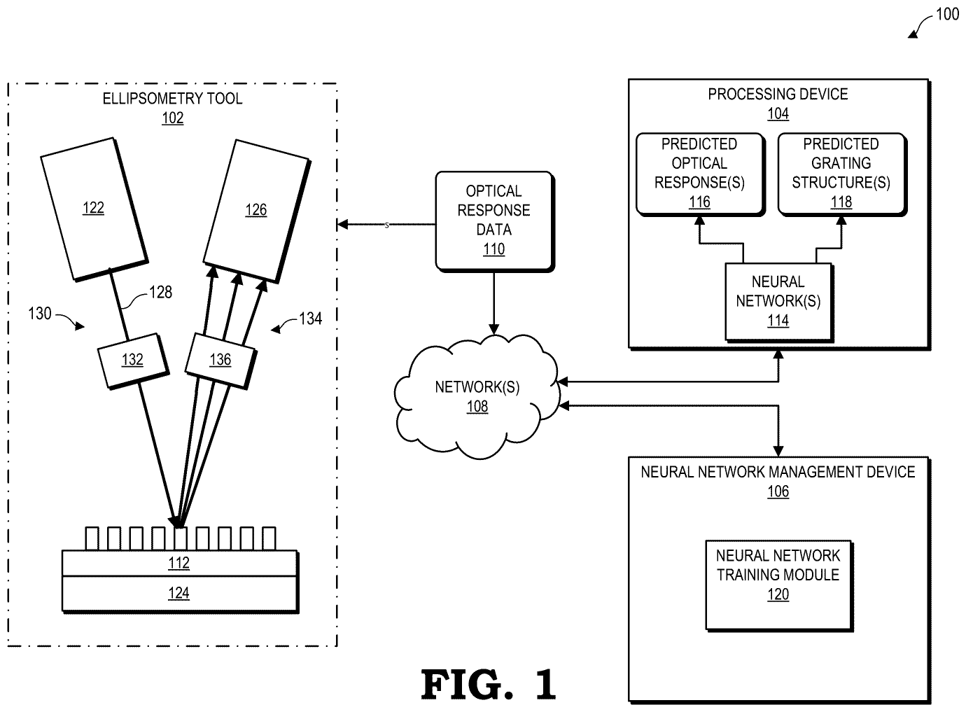

FIG. 1 illustrates an example Optical Critical Dimension (OCD) metrology system 100 capable of implementing the techniques described herein for predicting/inferring the structure of a grating. It should be understood that the techniques described herein are not limited to any specific OCD metrology system. Instead, the techniques described herein can be implemented by any OCD metrology system. Also, the present disclosure is not limited to the examples and context described herein, but rather the techniques described herein can be applied to predict/infer the structure of gratings used in any environment or application. Moreover, the OCD metrology system 100, in at least some embodiments, operates in a fabrication or production line. However, in other embodiments, the OCD metrology system 100 is implemented in other operating environments.

The OCD metrology system 100 predicts or estimates one or more of the properties of interest, such as critical dimensions, the three-dimensional shapes, and the profiles of a sample under consideration, such as a grating. A grating is a periodic optical structure that diffracts light into several beams traveling in different directions. Gratings typically include a series of equally spaced lines, slits, or grooves, which can be made on a reflective or transmissive material. The size, shape, and spacing of these lines or grooves, collectively referred to as the grating's “geometry” determine how the grating interacts with light. Gratings are used in various applications including augmented reality waveguides (e.g., incouplers, exit-pupil-expanders, and outcouplers), computer memory technology, and the like.

The properties of interest for a grating include, for example, grating period (pitch), grating width, grating height (or depth), grating sidewall angle, grating shape, material properties, and the like. The grating period (pitch) is the distance from one grating line (or feature) to the next. The grating width is the width of a grating line that, in combination with the grating period, determines the duty cycle of the grating (i.e., the fraction of one period that is occupied by a grating line). The grating height (or depth), is the height (or depth) of the grating lines. The grating sidewall angle is the angle between the grating sidewall and the substrate plane. The grating shape is the cross-sectional shape of the grating lines (e.g., rectangular, trapezoidal, sinusoidal, etc.). The material properties include optical constants such as the refractive index and extinction coefficient, which can influence how light interacts with the grating.

In at least some embodiments, the OCD metrology system 100 includes an ellipsometry data tool 102, one or more processing devices 104, and one or more neural network managing devices 106 (or “managing device 106” for brevity). Although FIG. 1 shows the managing device 106 as being separate from the processing device 104, in other embodiments, the processing device 104 and the managing device 106 are implemented as part of the same system. In at least some embodiments, one or more of these components of the OCD metrology system 100 are coupled to a network(s) 108, such as a wired or wireless network, or a combination thereof, such as a wireless network, a wired network connection, the Internet, and the like. However, in other embodiments, two or more of the OCD metrology system components are directly coupled to each other.

As described in greater detail below, the ellipsometry data tool 102 is configured to generate measured optical response data 110. The optical response data 110 represents how light interacts with an optical grating 112 (herein referred to as “grating”). Examples of optical response data 110 include scattered light spectra, such as ellipsometric data (or other types of data that characterize the scattered light, such as intensity as a function of wavelength or angle, or polarization state as a function of wavelength or angle), Mueller matrices, and the like. The processing device 104 receives the measured optical response data 110 from the ellipsometry data tool 102. One or more trained neural networks 114 implemented by the processing device 104 predict an optical response 116 (e.g., predicted light interactions) for the grating 112 and perform backpropagation to output a predicted maximum-likelihood structure 118 of the grating 112 based on the measured optical response data 110 and the predicted optical response data 116. The predicted maximum-likelihood structure 118 is used to, for example, pass or fail the grating 112 under consideration, adjust fabrication processes to obtain a grating structure that more closely conforms to design specifications, or the like. The managing device 106 includes a training module 120 that trains the one or more neural networks 114 to predict the optical response of a grating 112 that is used during a regression process to predict the structure of the grating 112. It should be understood that although FIG. 1 shows the managing device 106 as being separate from the processing device 104, the managing device 106, in at least some embodiments, is part of the processing device 104.

The ellipsometry data tool 102, in at least some embodiments, is controlled by the processing device 104 or another processing system or controller (not shown). In at least some embodiments, the ellipsometry data tool 102 includes one or more light sources 122, a sample stage 124, and a detector 126. It should be understood that the ellipsometry data tool 102 can include additional (or less) components than shown in FIG. 1. The light source(s) 122 generates one or more light beams 128 at one or more angles of incidence. The light beam(s) 128 includes a selected wavelength (or range of wavelengths) of light including, for example, ultraviolet (UV) radiation, visible radiation, or infrared (IR) radiation. In at least some embodiments, the light source 122 is a laser source, a lamp source, a light-emitting diode (LED) source, or the like. The light source 122, in at least some embodiments, directs the one or more light beams 128 to a grating 112 via an illumination pathway 130. The grating 112, in at least some embodiments, is a single grating, a wafer or substrate comprising multiple gratings, or the like. In at least some embodiments, the grating 112 is located on a sample stage 124, which is configured to move, rotate, or a combination thereof to allow different parts of the grating 112 to be illuminated and measured.

The ellipsometry data tool 102, in at least some embodiments, includes components 132, such as one or more of an optical system or polarization control elements, in the illumination pathway 130. The optical system includes, for example, various lenses, mirrors, beam splitters, filters, and the like used to direct the light from the light source 122 onto the grating 112. The polarization control elements include, for example, a polarizer, and a waveplate (or similar component). The polarizer and waveplate are used to set the state of polarization of the incident light.

When the light beam 128 interacts with the grating 112, the light beam 128 is reflected, absorbed, or scattered depending on the properties of the grating 112. For example, the periodic structure of the grating 112 causes different wavelengths of light to interact with it differently, producing interference effects that depend on the dimensions of the grating 112 and the optical properties of the grating's material(s). The interaction of the light beam 128 with the grating 112 changes the polarization state of the light beam 128. This change in polarization state depends on properties such as the grating's period, depth, shape, and the refractive index and absorption of the grating's material.

Portions of the light beam 128 reflected, diffracted, or scattered by the grating 112 are directed to the detector 126 via a collection pathway 134. The detector 126 collects/captures these portions of the light beam 128 to measure certain properties of the light beam 128 and converts the collected light into an electrical signal using, for example, photodiodes, photomultiplier tubes, or other light-sensitive devices. For example, the detector 126 measures the total intensity of the light, the intensity as a function of wavelength (providing spectral information), or the state of polarization of the light. In at least some embodiments one or more components 136, such as a waveplate (or a similar component) and an analyzer, are situated in the collection pathway 134 before the detector 126. The waveplate modifies the polarization state of light passing through it, and the analyzer analyzes the state of polarization of the collected light.

The detector 126, in at least some embodiments, outputs optical response data 110 associated with the grating 112. The optical response data 110, in at least some embodiments, includes ellipsometry data, such as ellipsometric parameters including Psi (Ψ) and Delta (Δ) measured across a range of wavelengths or frequencies. Psi is the amplitude ratio between p-polarized and s-polarized light after reflection or transmission and is typically expressed in degrees Delta is the phase difference between the p-polarized and s-polarized light after reflection or transmission and is also typically expressed in degrees. In spectroscopic ellipsometry, these parameters are measured at multiple wavelengths of light, providing a spectrum (or spectra when considering both parameters). The ellipsometric spectra provide information about the optical and physical properties of the material or structure being measured, such as the size and shape of nanoscale structures or the thickness and optical constants (refractive index and extinction coefficient) of thin films. In other embodiments, the optical response data 110 includes Mueller matrices measured by the ellipsometry data tool 102 (or another component of the system 100). Mueller matrices describe how the state of polarization of a light wave changes as the light passes through or is reflected off the grating 112. Each Mueller matrix corresponds to a specific optical element or process that alters the state of polarization of light in a specific way.

The processing device 104 obtains the optical response data 110 generated by the detector 126. For example, the detector 126 generates an electrical signal representing the optical response data 110 that is received and converted into a digital form by the processing device 104. As described in detail below, the processing device 104 uses the optical response data 110 as input to the one or more neural networks 114 for predicting the structure 118 of the grating 112 under consideration. The predicted structure 118 of the grating 112 includes detailed dimensional and material properties of the grating 112, such as the grating period, the grating depth, the grating profile, the duty cycle or fill factor, the sidewall angle, material properties, and the like. The predicted structure 118 of the grating 112, in at least some embodiments, is used to pass/fail the grating 112, fed back into the fabrication/production system to adjust the fabrication process to correct fabrication errors, or the like.

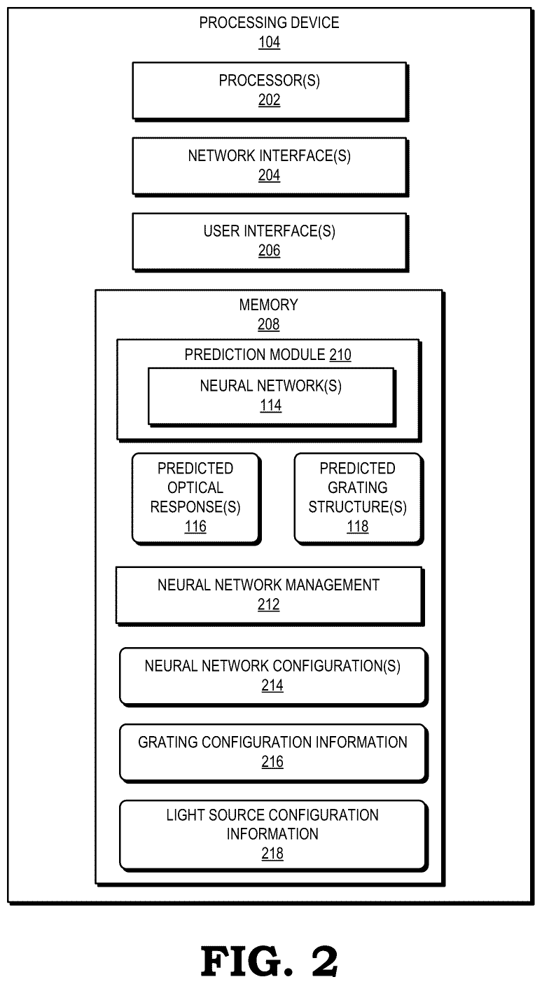

FIG. 2 illustrates example hardware configurations for the processing device 104 in accordance with some embodiments. Note that the depicted hardware configuration represents the processing components most directly related to the neural-network-based processes of one or more embodiments and omits certain components well-understood to be frequently implemented in such processing systems, such as displays, peripherals, power supplies, and the like. Further, although the hardware configuration is depicted as being located at a single component, the functionality, and thus the hardware components, of the processing device 104 instead can be distributed across multiple infrastructure components or nodes and can be distributed in a manner to perform the functions of one or more embodiments. Also, the processing device 104 includes one or more addition additional or fewer components than illustrated in FIG. 2.

In at least some embodiments, the processing device 104 is a desktop computer, a server, a portable computing device, a cloud-based computing device, or any other processing device capable of implementing one or more of the techniques described herein. The processing device 104, in at least some embodiments, includes one or more processors 202, one or more network interface(s) 204, one or more user interfaces 206, and memory/storage 208. The processor(s) 202 includes, for example, one or more central processing units (CPUs), graphics processing units (GPUs), machine-learning (ML) accelerator, tensor processing units (TPUs) or other application-specific integrated circuits (ASIC), or the like. The network interface(s) 204 enables the processing device 104 to communicate over one or more networks, such as network 108. The user interface(s) 206 enables a user to interact with the OCD metrology system 100. The memory/storage 208, in at least some embodiments, includes one or more computer-readable media that include any of a variety of media used by electronic devices to store data and/or executable instructions, such as random access memory (RAM), read-only memory (ROM), caches, Flash memory, solid-state drive (SSD) or other mass-storage devices, and the like. For ease of illustration and brevity, the memory/storage 208 is referred to herein as “memory 208” in view of the frequent use of system memory or other memory to store data and instructions for execution by the processor 202, but it will be understood that reference to “memory 208” shall apply equally to other types of storage media unless otherwise noted.

The one or more memories 208 of the processing device 104 store one or more sets of executable software instructions and associated data that manipulate the processor(s) 202 and other components of the processing device 104 to perform the various functions attributed to the processing device 104. The sets of executable software instructions include, for example, an operating system (OS) and various drivers (not shown), and various software applications. The sets of executable software instructions further include a prediction (or inference) module/component 210 and a neural network management component 212. As described below, the prediction module 210 implements one or more neural network models 114 (also referred to herein as “neural networks 114”) managed by the neural network management component 212 to replace full-wave solvers for predicting the interaction of light with a grating 112 and to perform regression to find the maximum-likelihood structure of the grating 112. In at least some embodiments, the neural network(s) 114 is a differentiable computational graph such that each node in a layer of the neural network 115 is a (differentiable) function of the previous layer. This configuration allows the parameters of the neural network to be trained using backpropagation (chain-rule differentiation). Although the neural network management component 212 is illustrated in FIG. 1 as being separate from the prediction module 210, the neural network management component 212, in at least some embodiments, is part of the prediction module 210.

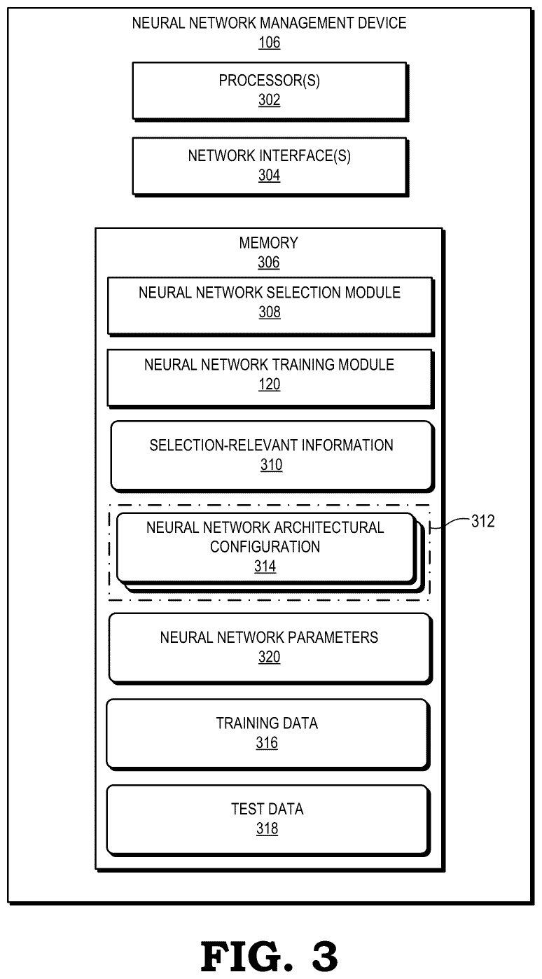

In at least some embodiments, the memory 208 of the processing device 104 also includes one or more neural network architecture configurations 214, grating configuration information 216, and light source configuration information 218. The neural network architecture configuration(s) 214 represent examples selected from a set 312 (FIG. 3) of candidate neural network architectural configurations maintained by the managing device 106. However, in other embodiments, the set 312 of candidate neural network architectural configurations is maintained by the processing device 104. Each neural network architecture configuration 214 includes one or more data structures having data and other information representative of a corresponding architecture and/or parameter configurations used by the neural network management component 212 to form a corresponding neural network 114 of the processing device 104. The information included in a neural network architectural configuration 214 includes, for example, parameters that specify a fully connected layer neural network architecture, a convolutional layer neural network architecture, a recurrent neural network layer, a number of connected hidden neural network layers, an input layer architecture, an output layer architecture, a number of nodes utilized by the neural network, coefficients (e.g., weights and biases) utilized by the neural network, kernel parameters, a number of filters utilized by the neural network, strides/pooling configurations utilized by the neural network, an activation function of each neural network layer, interconnections between neural network layers, neural network layers to skip, and so forth. Accordingly, the neural network architecture configuration 214 includes any combination of neural network formation configuration elements (e.g., architecture and/or parameter configurations) for creating a neural network formation configuration (e.g., a combination of one or more neural network formation configuration elements) that defines and/or forms a deep neural network (DNN).

The grating configuration information 216, in at least some embodiments, includes grating parameters such as grating type, grating period (pitch), grating width, grating height (or depth), grating sidewall angle, grating shape, material properties, and the like. The light source configuration information 218, in at least some embodiments, includes light source parameters (e.g., the wavelength (λ), wave number (k), which is defined as the spatial frequency, the angle of incidence, the plane of incidence, beam divergence, beam spot size, and the like), of the light beams 128 generated by the light source 122. In at least some embodiment, one or more of the grating configuration information 216 or the light source configuration information 218 are used by the processing device 104 or the management device 106 to a select network architectural configuration 314 for implementing one or more neural networks 114. For example, the processing device 104 or the management device 106 selects a network architectural configuration 314 that has been trained for the configuration of the grating 112 specified by the grating configuration information 216 and the illumination conditions of the ellipsometry data tool 102 specified by the light source configuration information 218.

FIG. 3 illustrates an example hardware configuration for the managing device 106 in accordance with some embodiments. Note that the depicted hardware configuration represents the processing components and communication components most directly related to the neural-network-based processes of one or more embodiments and omit certain components well-understood to be frequently implemented in such processing systems, such as displays, peripherals, power supplies, and the like. Further, although the hardware configuration is depicted as being located at a single component, the functionality, and thus the hardware components, of the managing device 106 instead can be distributed across multiple infrastructure components or nodes and can be distributed in a manner to perform the functions of one or more embodiments. Also, the managing device 106 includes one or more addition additional or fewer components than illustrated in FIG. 3.

In at least some embodiments, the managing device 106 is a desktop computer, a server, a portable computing device, a cloud-based computing device, or any other processing device capable of implementing one or more of the techniques described herein. The managing device 106, in at least some embodiments, includes one or more processors 302, one or more network interface(s) 304, and memory/storage 306. The processor(s) 302 includes, for example, one or more central processing units (CPUs), graphics processing units (GPUs), machine learning (ML) accelerator, tensor processing units (TPUs) or other application-specific integrated circuits (ASIC), or the like. The network interface(s) 304 enables the managing device 106 to communicate over one or more networks, such as network 108. The memory/storage 306, in at least some embodiments, includes one or more computer-readable media that include any of a variety of media used by electronic devices to store data and/or executable instructions, such as random access memory (RAM), read-only memory (ROM), caches, Flash memory, solid-state drive (SSD) or other mass-storage devices, and the like. For ease of illustration and brevity, the memory/storage 306 is referred to herein as “memory 306” in view of the frequent use of system memory or other memory to store data and instructions for execution by the processor 302, but it will be understood that reference to “memory 306” shall apply equally to other types of storage media unless otherwise noted.

The one or more memories 306 of the managing device 106 store one or more sets of executable software instructions and associated data that manipulate the processor(s) 302 and other components of the managing device 106 to perform the various functions attributed to the managing device 106. The sets of executable software instructions include, for example, an operating system (OS) and various drivers (not shown), and various software applications. The sets of executable software instructions further include one or more of a neural network selection module 308 or a training module 120.

The neural network selection module 308 operates to obtain, filter, and otherwise process selection-relevant information 310 from the processing device 104 (or another component of the OCD metrology system 100) and using this selection-relevant information 310 selects a neural network (NN) architectural configurations 314 from the candidate set 312 for implementation at the processing device 104. The processing device 104 uses the neural network architectural configuration(s) to form a corresponding neural network(s) 114. In at least some embodiments, the selection-relevant information 310 includes, for example, an indication of the grating implementation environment (e.g., waveguide, computer memory, etc.), the grating type, the grating configuration, the illumination conditions, and the like. In other embodiments, the selection-relevant information 310 includes the grating configuration information 216 and the light source configuration information 218. As such, an architectural configuration 314 is able to be selected based on one or more aspects/parameters of the grating 112.

After the neural network selection module 308 has made a selection, the neural network selection module 308 then initiates the transmission of an indication of the NN architectural configuration 314 selected for the processing device 104, such as via transmission of an index number associated with the selected configuration, transmission of one or more data structures representative of the neural network architectural configuration itself, or a combination thereof.

The training module 120 operates to manage the individual or joint training of neural networks defined by the NN architectural configurations 314 for the set 312 of candidate neural networks available to be employed at the processing device 104 using one or more sets of training data 316. The training, in at least some embodiments, includes training one or more neural networks defined by a NN architectural configuration(s) 314 while offline (that is, while not actively engaged in processing the optical response data 110, predicting light interactions, or predicting grating structures) and/or online (that is, while actively engaged in processing the optical response data 110, predicting light interactions, or predicting grating structures). For example, the training module 120 can individually (or jointly) train one or more neural networks defined by a NN architectural configuration(s) 314 using one or more sets of training data 316 to provide light interaction prediction functionality and regression functionality to find the maximum-likelihood structure of a grating. The offline or online training processes, in at least some embodiments, implement different prediction and regression parameters for different grating types, such as one-dimensional gratings, two-dimensional gratings, three-dimensional gratings, diffraction gratings, transmission gratings, reflection gratings, volume gratings, Fresnel gratings, binary gratings, waveguide-based gratings, gratings used in the fabrication of computer memory, and the like.

During training, the neural network defined by an NN architectural configuration 314, in at least some embodiments, adaptively learns based on supervised learning. In supervised learning, the neural network receives various types of input data as training data 316. The neural network processes the training data 316 to learn how to map the input to a desired output. As one example, the neural network receives one or more of grating configuration information 216, light source configuration information 218, optical response data (e.g., ellipsometry data or Mueller Matrices) or the like, and learns how to map this input training data to, for example, one or more of light interactions at different gratings or grating structures (e.g., grating period, the grating depth, the grating profile, the duty cycle or fill factor, the sidewall angle, material properties, and the like).

In at least some embodiments, the training procedure performed by the training module 120 of the management device 106 includes using labeled or known data as an input to the neural network(s), such as a DNN, being trained. The neural network analyzes the input using the nodes and generates a corresponding output. The training module 120 compares the corresponding output to truth data and adapts the algorithms implemented by the nodes to improve the accuracy of the output data. Afterward, the neural network applies the adapted algorithms to unlabeled input data to generate corresponding output data. The neural network uses one or both of statistical analysis and adaptive learning to map an input to an output. For instance, the neural network uses characteristics learned from training data to correlate an unknown input to an output that is statistically likely within a threshold range or value. This allows the neural network to receive complex input and identify a corresponding output.

After the training process has been completed, the training module 120, in at least some embodiments, assessed the performance of the trained neural network using a set of test data 318. In at least some embodiments, the training module 120 stores or associates the parameters 320, such as weights and biases, learned by the neural network during the training process with the NN architectural configuration 314 defining the neural network. The managing device 106, in at least some embodiments, sends an indication to the processing device 104 of one or more selected NN architectural configurations 314 along with their associated learned parameters 320. The processing device 104 uses the received NN architectural configuration(s) 314 including the associated parameters 320 to implement one or more trained neural networks 114.

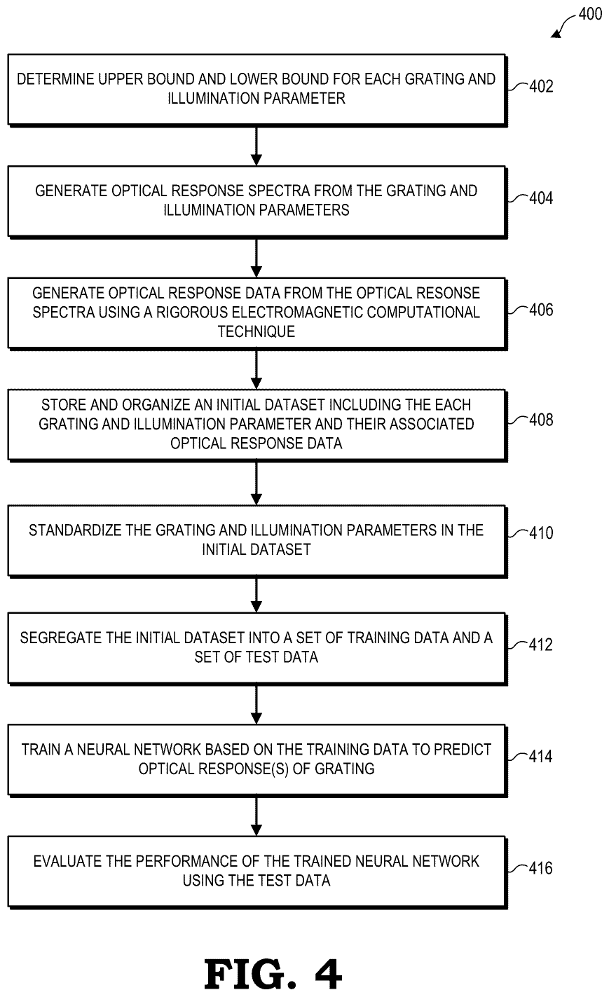

FIG. 4 illustrates an example method 400 for training one or more neural networks to predict the optical response (e.g., light interactions) of grating 112, such as an optical grating, in the form of ellipsometric data (e.g., Psi or Delta measurements) Mueller matrices, a combination thereof, or the like. It should be understood that method 400 is not limited to the sequence of operations shown in FIG. 4, as at least some of the operations can be performed in parallel or in a different sequence. Moreover, in at least some embodiments, the method 400 can include one or more different operations than those shown in FIG. 4.

At block 402, the training module 120 determines the bounds (e.g., lower bound and upper bound) for each grating parameter and illumination parameter to be used when generating an initial dataset. The bounds, in at least some embodiments, are determined from ground truth images of various gratings. Examples of the grating parameters include grating period (or pitch) A, grating thickness/height (in nanometers), fill factor, left sidewall angle, right sidewall angle, and the like. Examples of the illumination conditions include angle of incidence, azimuthal angle, and the like.

At block 404, the training module 120 generates optical response spectra, such as scattered light spectra or Mueller matrix spectra, by uniformly and independently sampling from each of the grating and illumination parameters. At block 406, the training module 120 then calculates optical response data, such as one or more of ellipsometric data or Mueller matrices, using RCWA, FDTD, Discontinuous Galerkin Time-Domain (DGTD), or the like based on the optical response spectra. For example, as part of the RCWA process a grating and incident wave are defined by specifying the geometry, material properties, and periodicity of the grating, as well as the properties of the incident wave, such as its wavelength and angle of incidence. The RCWA process discretizes the geometry of the grating by breaking down the grating into a series of simpler spatial harmonics using Fourier transform. Each spatial harmonic can be thought of as a single “frequency” component of the grating structure. The RCWA process then solves Maxwell's equations, which govern the behavior of electromagnetic fields (E-fields) for each spatial harmonic. Solving the Maxwell's equations provides the electric and magnetic fields within the grating structure for each spatial harmonic, which can be represented in terms of transfer matrices. Each transfer matrix describes how a specific harmonic transforms as it propagates through the grating. After obtaining the solutions for each harmonic, the RCWA process sums the solutions to obtain the overall fields of the transmitted and reflected light. The RCWA process then computes the Stokes vectors of the transmitted and reflected light using the calculated E-fields. The Stokes vectors provide a description of the polarization state of the light, including its degree and type of polarization (linear, circular, or elliptical). Finally, the RCWA process determines the Mueller matrix by comparing the Stokes vectors of the incident light and the transmitted or reflected light. A Mueller matrix is typically a 4×4 matrix that represents the transformation of the polarization state of the light as it interacts with the grating. Each element of the matrix can be calculated as a function of the incident, transmitted, and reflected Stokes vectors. The resulting Mueller matrix provides a complete description of how the grating alters the polarization state of the incident light. In at least some embodiments, the training module 120 generates Mueller matrices for a plurality of measured angles of incidence and a plurality of wavelengths of light across multiple different values for one or more of the grating and illumination parameters.

At block 408, the training module 120 stores and organizes an initial dataset including the data provided as input to the RCWA process and the resulting optical response data (e.g., one or more of ellipsometric data or Mueller matrices) in one or more data structures. For example, the training module 120 associates each calculated Mueller matrix with its corresponding set of grating parameter values and light source parameter values in a database (or other data structure). At block 410, the training module 120 standardizes each RCWA input value to fit within a [−1, +1] interval according to:

$$\hat{{p}_{ι}} = \frac{{p}_{i} - \frac{1}{2} ( U S L + L S L )}{\frac{1}{2} ( USL - L S L )} , \qquad ( EQ . 1 )$$

where \hat{p}ₜ is the standardized value of the input (fitting) parameter, USL is the upper bound value of the input parameter, and LSL is the lower bound value of the input parameter.

At block 412, the training module 120 segregates the initial dataset into a set of training data 316 and a set of test data 318. At block 414, the training module 120 trains one or more neural networks by iteratively adjusting the weights and biases of the neural network through backpropagation and gradient descent. The goal is to minimize the difference (or “error”) between the predictions made by the neural network and the actual outcomes in the set of training data 316. This “error” is typically calculated using a loss function. The learning process involves many iterations of making predictions on the set of training data 316, calculating the loss, and adjusting the weights and biases of the neural network being trained to reduce the loss.

The training process results in a trained neural network 114 that outputs predicted light interactions, in the form of optical response data 116 (e.g., scattered light spectra including ellipsometric data, Mueller matrices, or the like) for a grating 112. Stated differently, during the training process, the neural network learns to associate the inputs (grating parameters and illumination conditions) with the outputs (optical response). As such, the training process teaches the neural network the “forward problem”, i.e., the mapping from grating and illumination parameters to optical response data. Once trained, the neural network 114 is configured to predict the optical response for any given grating structure within the parameter space it was trained on. As described below, the prediction module 210 uses the trained neural network 114 to solve the inverse problem. For example, given a set of optical response data 110 measured by the ellipsometry data tool 102, the network can predict (via back-propagation) the grating parameters that produce the input optical response(s).

At block 416, the training module 120, in at least some embodiments, uses the set of test data 318 to evaluate the final neural network model 114 after training. The set of test data 318 is not used during the training process and, therefore, provides an “unseen” dataset to assess the model's performance. In at least some embodiments, the training module 120 further segregates the initial dataset in a set of validation data. In these embodiments, the training module 120 uses the set of validation data during the model training process to evaluate the model's performance at each iteration or epoch. The set of validation data helps in hyperparameter (e.g., learning rate, number of layers, number of nodes (neurons) per layer, activation function, batch size, epochs, etc.) tuning and in deciding when to stop training (early stopping) to avoid overfitting. Hyperparameter tuning involves selecting the best set of hyperparameters to minimize the loss function of the neural network on a validation set. Techniques for hyperparameter tuning include grid search, random search, and more sophisticated methods including Bayesian optimization. In at least some embodiments, the training module 120 stores the learned configuration and parameters of the trained neural network as a neural network architectural configuration 314. As described above, the processing device 104 uses the neural network architectural configuration 314 to implement the corresponding trained neural network 114. The training process described above, in at least some embodiments, is repeated for a plurality of different grating and illumination configurations to train a plurality of different neural networks and corresponding neural network architectural configurations.

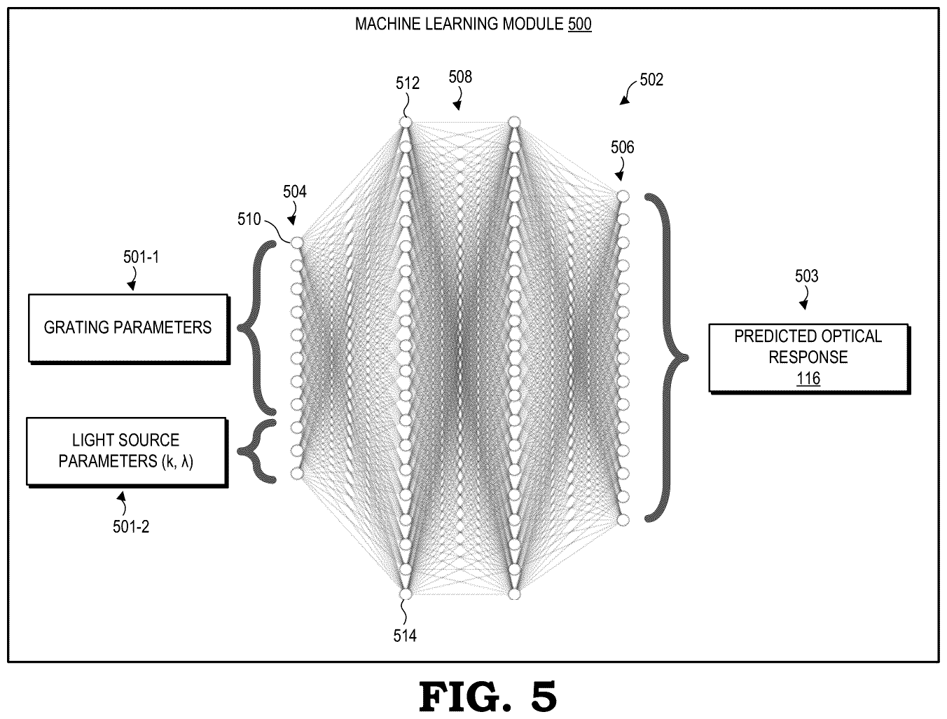

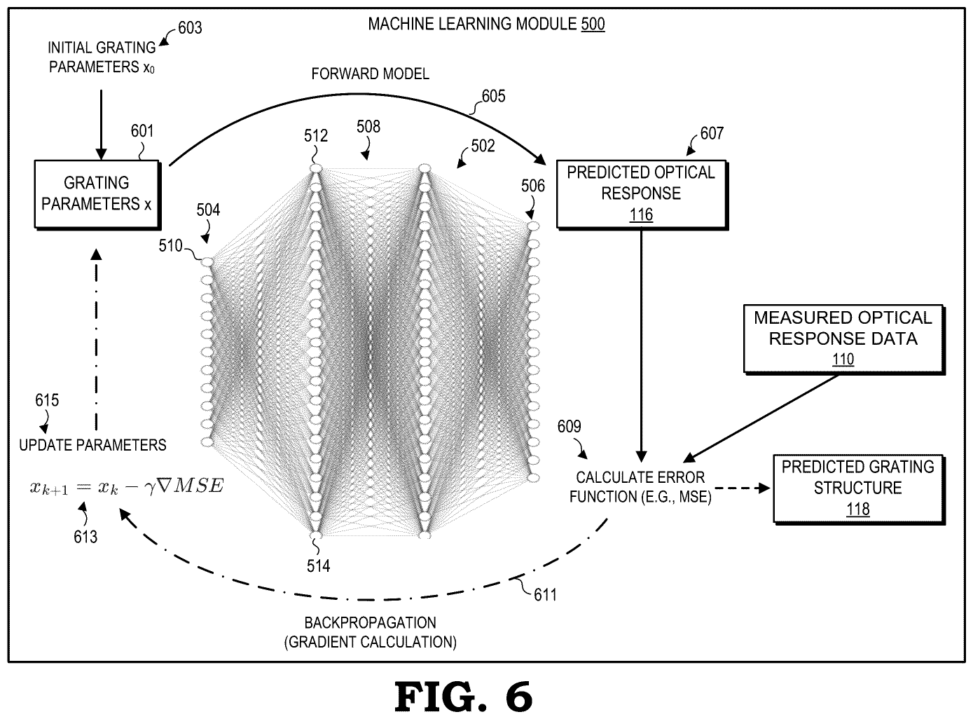

FIG. 5 and FIG. 6 illustrate an example machine learning (ML) module 500 for implementing a neural network in accordance with some embodiments. For example, FIG. 5 illustrates the ML 500 implementing a neural network during the training process described above with respect to FIG. 4 to predict the optical response of a grating 112, and FIG. 6 illustrates the ML module 500 implementing the trained neural network 114 and iteratively performing forward pass and backpropagation processes to predict the structure of a grating 112 based on optical response data 110 measured by the ellipsometry data tool 102. The ML module 500 illustrates an example module, such as the prediction module 210 of the processing device 104, for implementing one or more of the neural networks described herein.

In the depicted example, the ML module 500 implements at least one deep neural network (DNN) 502 with groups of connected nodes (e.g., neurons and/or perceptrons) organized into three or more layers. The nodes between layers are configurable in a variety of ways, such as a partially connected configuration where a first subset of nodes in a first layer is connected with a second subset of nodes in a second layer, a fully connected configuration where each node in a first layer is connected to each node in a second layer, etc. A neuron processes input data to produce a continuous output value, such as any real number between 0 and 1. In some cases, the output value indicates how close the input data is to a desired category. A perceptron performs linear classifications on the input data, such as a binary classification. The nodes, whether neurons or perceptrons, can use a variety of algorithms to generate output information based upon adaptive learning. Using the DNN 502, the ML module 500 performs a variety of different types of analysis, including single linear regression, multiple linear regression, logistic regression, stepwise regression, binary classification, multiclass classification, multivariate adaptive regression splines, locally estimated scatterplot smoothing, and so forth.

In the depicted examples, the DNN 502 includes an input layer 504, an output layer 506, and one or more hidden layers 508 positioned between the input layer 504 and the output layer 506. Each layer has an arbitrary number of nodes, where the number of nodes between layers can be the same or different. That is, the input layer 504 can have the same number and/or a different number of nodes as output layer 506, the output layer 506 can have the same number and/or a different number of nodes than the one or more hidden layer 508, and so forth.

Node 510 corresponds to one of several nodes included in input layer 504, wherein the nodes perform separate, independent computations. As further described, a node receives input data and processes the input data using one or more algorithms to produce output data. Typically, the algorithms include weights and/or coefficients that change based on adaptive learning. Thus, the weights and/or coefficients reflect information learned by the neural network. For example, in at least some embodiments, the nodes in the input layer 504 receive input 501. During the training process described above with respect to FIG. 4, the input 501 is training data 316, such as grating parameters 501-1 and light source parameters 501-2 (e.g., illumination conditions), as shown in FIG. 5. Each node 512 in the hidden layer 508 receives inputs from all nodes in the previous layer. Each input is multiplied by a corresponding weight, which is a measure of the input's importance in determining the node's output. All the weighted inputs at a node in the hidden layer are summed together, along with a bias term which is similar to the intercept in a linear regression model. The sum is then passed through an activation function which introduces non-linearity into the model, allowing the model to learn and represent more complex patterns. Examples of activation functions include a sigmoid function, a hyperbolic tangent function (tan h), or a Rectified Linear Unit (ReLU), or the like. The output of the activation function is the output of the node. The outputs of all nodes in a hidden layer 508 serve as the inputs to the nodes in the next layer. This continues layer by layer, until the output layer 506 is reached. Also, each node in a layer can, in some cases, determine whether to pass the processed input data to one or more next nodes.

To illustrate, after processing input data, node 510 can determine whether to pass the processed input data to one or both of node 512 and node 514 of the hidden layer 508. Alternatively or additionally, node 510 passes the processed input data to nodes based upon a layer connection architecture. This process can repeat throughout multiple layers until the DNN 502 generates an output 503 using the nodes (e.g., node 516) of output layer 506. For example, given the input 501 during a training process, the DNN 502 in FIG. 5 predicts at its output 503 optical responses 116 of gratings in the form of Mueller matrix elements (e.g., a set of Mueller matrices obtained across a range of wavelengths, or spectra, of light), scattered light spectra such as ellipsometric data, or the like.

After the DNN 502 has been trained, the ML module 500 implements the trained DNN 502 to generate an output by solving the inverse problem of determining the grating structure parameters given the measured optical response data 110. For example, the ML module 500 provides input grating parameters 601 to the trained DNN 502, such as an initial set of grating parameters x₀ 603. In at least some embodiments, the input 601 also includes light source parameters. The ML module 500 performs forward modeling process 605 (e.g., forward propagation or forward pass) by feeding the input grating parameters 601 through the DNN 502 to generate an output 607, such as a predicted optical response 116, based on the input grating parameters 601. After the forward pass, the output 607 of the network is compared to the measured optical response data 110, and a loss 609 is calculated using a loss function, such as MSE. This loss 609 gives an indication of how far off the network's predictions were. The ML module 500 then performs backpropagation 611 to propagate the loss 609 back through the DNN 502 in order to update input grating parameters 601 and minimize the loss 605. For example, the ML module 500 calculates the gradient 613 of the loss function with respect to the input grating parameters 601. Once the gradients 613 are calculated, the ML module 500 uses the gradients 613 to update 615 the input grating parameters 601 using, for example, an optimization algorithm, such as gradient descent. The ML module 500 then performs another forward pass using the updated input grating parameters 601. The forward pass and backpropagation processes, in at least some embodiments, are repeated one or more additional times until the input grating parameters 601 result in the predicted optical response output by the DNN 502 having a loss 609 that satisfies a threshold (e.g., the cost function is minimized). These input grating parameters 601 are then output as the predicted grating structure 118 of the grating 112 under consideration. Examples of the predicted structure 118 include grating period (pitch), grating depth/height, duty cycle or fill factor, sidewall angle, shape of the grating features, and the like.

As described above, a neural network can also employ a variety of architectures 214 that determine what nodes within the neural network are connected, how data is advanced and/or retained in the neural network, what weights and coefficients the neural network is to use for processing the input data, how the data is processed, and so forth. These various factors collectively describe a neural network architecture configuration, 214 such as the neural network architecture configurations briefly described above. To illustrate, a recurrent neural network, such as a long short-term memory (LSTM) neural network, forms cycles between node connections to retain information from a previous portion of an input data sequence. The recurrent neural network then uses the retained information for a subsequent portion of the input data sequence. As another example, a feed-forward neural network passes information to forward connections without forming cycles to retain information. While described in the context of node connections, it is to be appreciated that a neural network architecture configuration 214 can include a variety of parameter configurations that influence how the DNN 502 or other neural network processes input data.

A neural network architecture configuration 214 of a neural network can be characterized by various architecture and/or parameter configurations. To illustrate, consider an example in which the DNN 502 implements a convolutional neural network (CNN). Generally, a convolutional neural network corresponds to a type of DNN in which the layers process data using convolutional operations to filter the input data. Accordingly, the CNN architecture configuration can be characterized by, for example, pooling parameter(s), kernel parameter(s), weights, and/or layer parameter(s).

A pooling parameter corresponds to a parameter that specifies pooling layers within the convolutional neural network that reduce the dimensions of the input data. To illustrate, a pooling layer can combine the output of nodes at a first layer into a node input at a second layer. Alternatively or additionally, the pooling parameter specifies how and where in the layers of data processing the neural network pools data. A pooling parameter that indicates “max pooling,” for instance, configures the neural network to pool by selecting a maximum value from the grouping of data generated by the nodes of a first layer and use the maximum value as the input into the single node of a second layer. A pooling parameter that indicates “average pooling” configures the neural network to generate an average value from the grouping of data generated by the nodes of the first layer and uses the average value as the input to the single node of the second layer.

A kernel parameter indicates a filter size (e.g., a width and a height) to use in processing input data. Alternatively or additionally, the kernel parameter specifies a type of kernel method used in filtering and processing the input data. A support vector machine, for instance, corresponds to a kernel method that uses regression analysis to identify and/or classify data. Other types of kernel methods include Gaussian processes, canonical correlation analysis, spectral clustering methods, and so forth. Accordingly, the kernel parameter can indicate a filter size and/or a type of kernel method to apply in the neural network. Weight parameters specify weights and biases used by the algorithms within the nodes to classify input data. In at least some embodiments, the weights and biases are learned parameter configurations, such as parameter configurations generated from training data. A layer parameter specifies layer connections and/or layer types, such as a fully-connected layer type that indicates to connect every node in a first layer (e.g., output layer 506) to every node in a second layer (e.g., hidden layer 508), a partially-connected layer type that indicates which nodes in the first layer to disconnect from the second layer, an activation layer type that indicates which filters and/or layers to activate within the neural network, and so forth. Alternatively or additionally, the layer parameter specifies types of node layers, such as a normalization layer type, a convolutional layer type, a pooling layer type, and the like.

While described in the context of pooling parameters, kernel parameters, weight parameters, and layer parameters, it will be appreciated that other parameter configurations can be used to form a DNN consistent with the guidelines provided herein. Accordingly, a neural network architecture configuration can include any suitable type of configuration parameter that a DNN can apply that influences how the DNN processes input data to generate output data.

The architectural configuration 214 of the ML module 500, in at least some embodiments, is based on the grating type of the sampled grating, the operating or implementation environment of the sampled grating, the grating configuration, the illumination conditions, and the like. In at least some embodiments, the device implementing the ML module 500 locally stores some or all of a set of candidate neural network architectural configurations 214 that the ML module 500 can employ. For example, a component can index the candidate neural network architectural configurations by a look-up table (LUT) or other data structure that takes as inputs one or more parameters, such as grating type, and outputs an identifier associated with a corresponding locally-stored candidate neural network architectural configuration 214 that is suited for operation in view of the input parameter(s). In other embodiments, it can be more efficient or otherwise advantageous to have the managing device 106 operate to select the appropriate neural network architectural configurations 314 to be employed ML module 500. In this approach, the managing device 106 obtains information representing some or all of the parameters that can be used in the selection process from processing device 104, and from this information selects a neural network architectural configuration(s) 314 from the set 312 of such configurations maintained at the managing device 106. The managing device 106 (or another component), in at least some embodiments, implements this selection process using, for example, one or more algorithms, a LUT, and the like. The managing device 106 then transmits to the processing device either an identifier or another indication of the neural network architectural configuration 314 selected for the ML module 500 of that device (in the event that each device has a locally stored copy), or the managing device 106 transmits one or more data structures representative of the neural network architectural configuration 314 selected for that device.

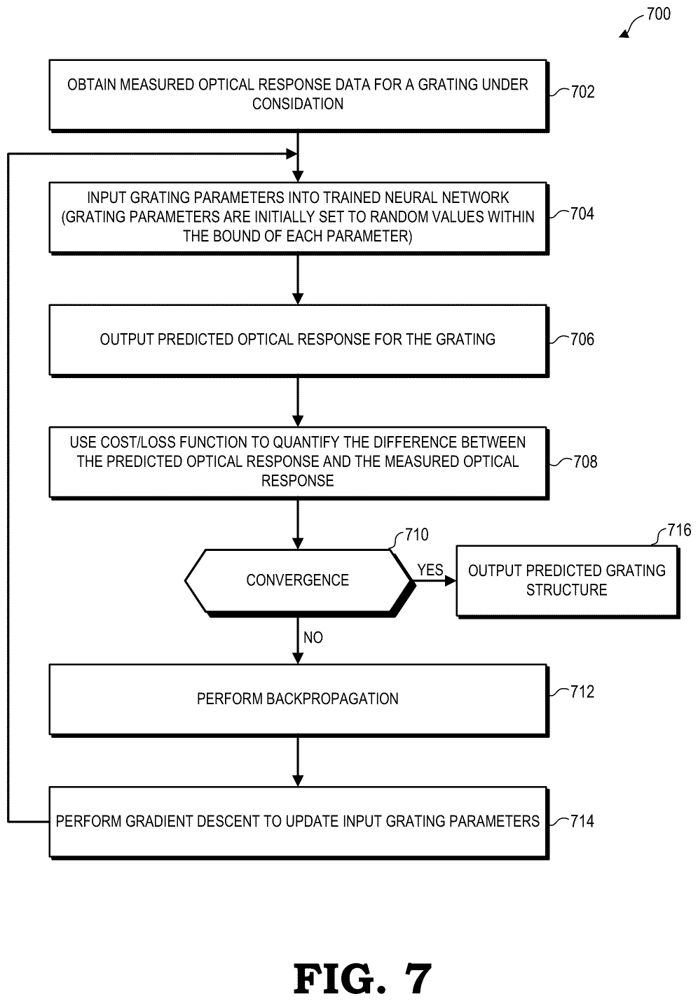

As described above, the processing device 104 implements the one or more trained neural networks 114 to predict the structure of the grating 112 under consideration. FIG. 7 illustrates an example method 700 for predicting the structure of a grating 112 under consideration. It should be understood that method 700 is not limited to the sequence of operations shown in FIG. 7, as at least some of the operations can be performed in parallel or in a different sequence. Moreover, in at least some embodiments, the method 700 can include one or more different operations than those shown in FIG. 7.

At block 702, the prediction module 210 of the processing device 104 obtains optical response data 110 measured by ellipsometry data tool 102. At block 704, during a forward propagation phase, the prediction module 210 provides input grating parameters (e.g., grating period, grating depth, sidewall angle, etc.) to the neural network 114. In at least some embodiments, the first input grating parameters provided to the neural network 114 are initial guesses. These initial guesses, in at least some embodiments, are random (within the bound for each parameter) or based on some prior knowledge of the grating 112. At block 706, the neural network 114 outputs a predicted optical response 116 for the grating 112 based on the input grating parameters.

At block 708, as part of a regression process, the prediction module 210 uses a cost/loss function to compare the predicted optical response 116 to the actual measured optical response data 110. For example, the network 114 uses the cost function to measure the difference between the predicted optical response 116 and the actual response data 110. The cost function quantifies the error in the prediction. One example of a cost function is Mean Squared Error (MSE), which is the average of the squared differences between the predicted and actual responses. In at least some embodiments, an MSE cost function is defined according to:

$$MSE ∼ {\sum }_{M} {\sum }_{i , j} {( {M}_{i , j}^{N N} ( λ , p ) - {M}_{i , j}^{E L S} ( λ ) )}^{2} , \qquad ( EQ . 2 )$$

where M_{i,j}^{NN}(λ,p) is the (i,j)^{th} predicted Mueller matrix element at wavelength λ for a particular set of grating parameters p which forms part of the predicted optical response 116, and M_{i,j}^{ELS}(λ) is likewise the (i,j)^{th} actual Mueller matrix element at wavelength λ which forms part of the actual response 110. Summations are performed over all independent elements (i,j) of the Mueller matrix and over multiple Mueller matrices M associated with different illumination conditions (e.g., angle of incidence, azimuthal angle, wavelength).

MSE is a function of the grating parameters p:

$$f ( p ) = M S E ( p ) . \qquad ( EQ . 3 )$$

As such, minimizing the MSE by varying p provides the maximum likelihood structure of the grating 112. In at least some embodiments, the prediction module 210 adjusts the cost function to correct for non-ideal measurement collection by the ellipsometer data tool 102 of the grating 112, such as finite beam divergence (in which the incident light source is formed by a cone of rays rather than a perfect plane wave), and finite spectral resolution (which “smears” out some features of the Mueller matrices in the wavelength λ). In the first case, finite beam divergence (FBD), the predicted Mueller matrix can be rigorously written as a weighted incoherent sum of Mueller matrices as (expression not normalized):

$${M}_{i , j}^{NN , FBD} ( λ , p , {θ}_{0} , {ϕ}_{0} ) ∼ {\int }_{{θ}_{0} - Δ}^{{θ}_{0} + Δ} sin θ d θ {\int }_{{θ}_{0} - Δ}^{{θ}_{0} + Δ} d ϕ {M}_{i , j}^{N N} ( λ , p , θ , ϕ ) , \qquad ( EQ . 4 )$$

where θ₀ and ϕ₀ are the nominal angle of incidence and azimuthal angle (respectively) of the light source of the measurement system with respect to the grating orientation, and 2Δ is the full width beam divergence of the light source of the measurement system.

However, due to the often slight variation in θ and ϕ, the integrand in the above expression M_{i,j}^{NN}(λ,p,θ,ϕ) can be approximated as a Taylor expansion about θ₀ and ϕ₀ involving the gradient and higher-order derivatives, which, in at least some embodiments, is calculated by backpropagation:

$${M}_{i , j}^{N N} ( λ , p , θ , ϕ ) ∼ {M}_{i , j}^{N N} ( λ , p , {θ}_{0} , {ϕ}_{0} ) + ( θ - {θ}_{0} ) \frac{\partial {M}_{i , j}^{N N}}{\partial {θ}_{0}} + ( ϕ - {ϕ}_{0} ) \frac{\partial {M}_{i , j}^{N N}}{\partial {ϕ}_{0}} + higher order terms . \qquad ( EQ . 5 )$$

In the second case, finite spectral bandwidth (FSB), the predicted Mueller matrix can be M_{i,j}^{NN} can be convolved in wavelength with the spectral response of the measurement system 102 as (expression not normalized):

$${M}_{i , j}^{NN , FSB} ( {λ}_{0} , p ) ∼ {\int }_{{λ}_{0} - δ}^{{λ}_{0} + δ} g ( λ ) {M}_{i , i}^{N N} ( λ , p , ) . \qquad ( EQ . 6 )$$

In both cases, the resulting MSE function remains a differentiable model with respect to the grating parameters p.

In at least some embodiments, as part of setting up the regression process, the prediction module 210 sets bounds on fitting parameters pᵢ, such as grating period (or pitch) Λ, grating substrate thickness, grating thickness/height, fill factor, left sidewall angle, right sidewall angle, and the like. The prediction module 210 also standardizes each parameter according to EQ. 1 so that the parameters fit within a [−1, +1] interval. In at least some embodiments, the prediction module 210 uses a multiplicative regularization term to bound the search space. Stated differently, the regularization term prevents overfitting by adding a penalty to the cost function for predictions that have large deviations from the nominal expected parameter space by evaluating the total cost/loss as the product of the original loss function and the regularization term.

At block 710, the prediction module 210 determines if the cost/loss (or change in cost/loss) between predicted optical response 116 and the measured optical response data 110 is below or within a specified threshold, indicating convergence. If so, the method 700 flows to block 716. However, if convergence has not occurred, then, at block 712, the prediction module 210 initiates (or continues) a backpropagation process to adjust the current input grating parameters to minimize the difference between the predicted optical response 116 and the measured optical response data 110. Stated differently, the prediction module 210 uses the neural network 114 in reverse to find input grating parameters that produce a predicted optical response 116 that converges with the measured optical response data 110. As part of the backpropagation process, the calculated error (cost/loss) is propagated back through the neural network 114. The backpropagation process calculates the gradients of the cost function with respect to each grating parameter. The gradients indicate how much each parameter contributed to the error between the predicted optical response 116 and the measured optical response data 110, and further indicate how much the loss would change for a small change in each grating parameter, giving a direction in which to adjust the parameters to reduce the cost/loss. The prediction module 210 applies the chain rule to propagate derivatives backward through the neural network 114. The chain rule of calculus allows the derivative of a composite function to be expressed in terms of the derivatives of its constituent functions.

In at least some embodiments, the prediction module 210 uses automatic differentiation (or auto-differentiation) to implement the backpropagation process. Automatic differentiation is a set of techniques to numerically evaluate derivatives and allows for the efficient computation of gradients that are needed for the gradient descent optimization process described below. Automatic differentiation is performed by breaking down complex derivative expressions into simple elementary operations for which derivatives are known and then combining the elementary operations using the chain rule to compute the required gradients.

At block 714, the prediction module performs an optimization process, such as gradient descent, to adjust the current input grating parameters in the direction of steepest descent (i.e., along the negative gradient), with the goal of finding the input grating parameters that minimize the difference (cost/loss value) between the predicted and actual optical responses. Stated differently, gradient descent is performed to find the minimum of f(p)=MSE(p). In at least some embodiments, the prediction module 210 chooses initial starting points pᵢ for the gradient descent process by sampling uniformly (and independently) from a specified interval, such as the [−1, 1] interval. During the gradient descent process, the values of the current input grating parameters are updated in the direction opposite to the gradient. This is done by subtracting the gradient of the cost function multiplied by a learning rate from the current input grating parameter values. Stated differently, a fraction of the gradient is subtracted from the current input grating parameter values. The learning rate is a hyperparameter that determines the step size during each iteration while moving towards a minimum of the cost/loss function.

As such, because the neural network 114 is defined as a differentiable computational graph, the gradient (or Jacobian) of the neural network outputs with respect to the inputs is able to be calculated with a single function evaluation. Traditionally, it would take on the order of 2p evaluations of the MSE function to compute the gradient of a function having p parameters. Therefore, the back-calculation of the input grating parameters is improved by a factor of p, which is on the order of 10, compared to traditional processes.

After the input grating parameters have been updated, the method 700 returns to block 704. The prediction module 210 inputs the updated grating parameters to the neural network 114 and the processes described above with respect to blocks 706 to 714 are performed again but based on the updated grating parameters and a different predicted optical response generated by the neural network 114. The processes described above with respect to blocks 704 to 716 are iteratively repeated until the cost/loss (or change in cost/loss) between the predicted optical response 116 and the measured optical response data 110 is below a specified threshold, indicating convergence. When convergence is detected, the method 700 flows to block 716, and the prediction module 210 outputs the current input grating parameters as the predicted grating structure 118 for the grating 112. The predicted grating structure 118, in at least some embodiments, provides predicted grating parameters such as grating period (pitch), grating width, grating height (or depth), grating sidewall angle, grating shape, material properties, and the like. In at least some embodiments, one or more operations are then performed based on the predicted grating structure 118. The predicted grating structure 118, in at least some embodiments, is presented to a user on a display, locally stored, remotely stored, transmitted to a user via one or more electronic communication mechanisms, a combination thereof, or the like. In at least some embodiments, the predicted grating structure 118 is also presented or stored with the measured optical response data 110.

In one example, the predicted grating structure 118 is compared against the design specifications for the grating 112. If one or more parameters provided by the predicted grating structure 118 deviate from the design specification by more than a specified threshold, the grating 112 is failed and removed from the production line. Otherwise, the grating 112 is passed and maintained. In another example, if one or more parameters provided by the predicted grating structure 118 deviate from the design specification by more than a specified threshold, the predicted grating structure 118 is fed back into the fabrication/production system to adjust one or more fabrication parameters of the grating to correct fabrication errors. Otherwise, the current fabrication parameters are maintained.

In at least some embodiments, in addition to the prediction module 210 not only calculates gradients but also evaluates higher-order derivatives, such as the Hessian. The Hessian provides an indication of the uncertainty for each back-calculated grating parameter, as well as how those parameters are coupled to one another. A conventional model with p parameters, would typically require on the order of p² evaluations to calculate the Hessian. However, the prediction module 210 implementing the neural network 114 of one or more embodiments only needs to perform a single evaluation to calculate the Hessian. Therefore, if the neural network has, for example, p=10 parameters, this results in approximately a 100-fold speed increase when calculating uncertainties and correlations in the neural network. The predicted grating structure 118, in at least some embodiments, is presented or stored with an uncertainty indication or measurement based on the Hessian evaluated for each back-calculated grating parameter.

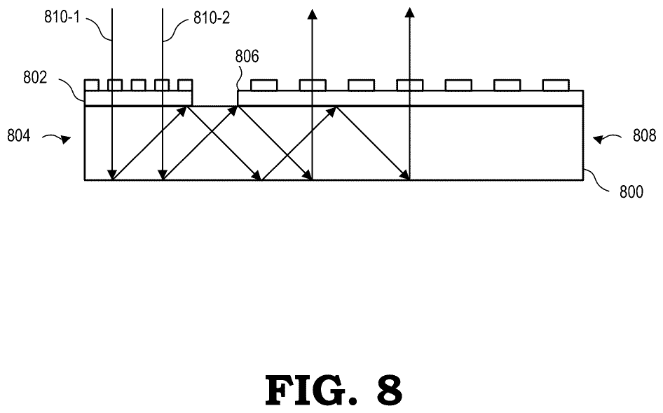

FIG. 8 illustrates an example waveguide 800, such as an augmented reality waveguide, implementing optical gratings (e.g., grating 112) capable of having its structure analyzed or verified using the OCD metrology techniques described herein. It should be understood that the OCD metrology techniques described herein are not limited to the gratings of FIG. 8 and are applicable to any grating configuration. The term “waveguide” as used herein, will be understood to mean a combiner using total internal reflection (TIR) or via a combination of TIR, specialized filters, and/or reflective surfaces to transfer light from an input coupler to an output coupler. In at least some display applications, the light, for example, is a collimated image, and the waveguide 800 transfers and replicates at least a portion of the collimated image to an eye of a user. The waveguide 800, in at least some embodiments, is formed by a plurality of layers, such as a first substrate layer, a partition element layer, and a second substrate layer.

The waveguide 800 includes a first grating 802, such as an input coupler (IC), disposed approximate to, for example, a first end 804 of the waveguide 800. The waveguide 800 also includes a second grating 806, such as an output coupler (OC), disposed approximate to, for example, a second end 808 of the waveguide 800. The second end 808, in at least some embodiments, is opposite the first end 804. In other embodiments, the waveguide 800 also includes a third grating, such as an exit pupil expander (EPE), which is not shown for brevity. In general, the terms “input coupler” and “output coupler” will be understood to refer to any type of optical grating structure, including, but not limited to, diffraction gratings, slanted gratings, blazed gratings, holograms, holographic optical elements (e.g., optical elements using one or more holograms), volume diffraction gratings, volume holograms, surface relief diffraction gratings, and/or surface relief holograms. In at least some embodiments, the first grating 802, the second grating 806, or both include one or more facets or reflective surfaces.

One or more of the first grating 802 or the second grating 806, in at least some embodiments, are configured as a transmissive grating (e.g., a transmissive diffraction grating or a transmissive holographic grating) that causes the first grating 802 or the second grating 806 to transmit light and to apply designed optical function(s) to the light during the transmission. In some embodiments, one or more of the first grating 802 or the second grating 806 is a reflective grating (e.g., a reflective diffraction grating or a reflective holographic grating) that causes the first grating 802 or the second grating 806 to reflect light and to apply designed optical function(s) to the light during the reflection.

In at least some embodiments, the first grating 802 receives light beams 810 (illustrated as beam 810-1 and light beam 810-2) emitted directly from a light source, such as a laser projection system, or receives light beams 810 emitted from a light source and reflected by another component, such as a scan mirror. In the present example, the light beams 810 received by the first grating 802 are relayed to the second grating 806 via the waveguide 800 using TIR. The light is then output to the eye of a user via the second grating 806. If the waveguide 800 includes an EPE, the EPE is implemented using a diffraction or other type of grating and is arranged in an intermediate stage between the first grating 802 and the second grating 806 to receive light that is coupled into waveguide 800 by the first grating 802, expand the light, and redirect the light towards the second grating 806. The second grating 806 then couples the light out of waveguide 800 (e.g., toward the eye of the user). In other embodiments, the EPE is combined with the second grating 806.

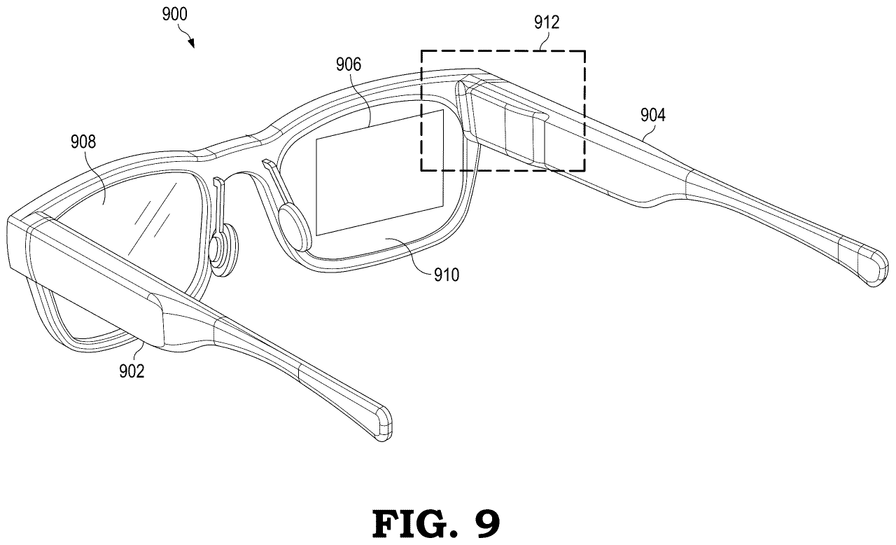

FIG. 9 illustrates an example display system 900, such as a near-to-eye device, capable of implementing a waveguide (e.g., waveguide 800) having gratings (e.g., grating 112, grating 802, or grating 806) that have been analyzed using the OCD metrology techniques described herein. It should be noted that, although the apparatuses and techniques described herein are not limited to this particular example, but instead may be implemented in any of a variety of display systems using the guidelines provided herein. In at least some embodiments, the display system 900 includes a support structure 902 that includes an arm 904, which houses an image source, such as laser projection system, configured to project images toward the eye of a user such that the user perceives the projected images as being displayed in FOV area 906 of a display at one or both of lens elements 908, 910. In the depicted embodiment, the display system 900 is a near-eye display system that includes the support structure 902 configured to be worn on the head of a user and has a general shape and appearance of an eyeglasses frame. The support structure 902 includes various components to facilitate the projection of such images toward the eye of the user, such as a laser projector, an optical scanner, a waveguide, gratings, such as the gratings (e.g., grating 112, grating 802, or grating 806) described above with respect to FIG. 1 to FIG. 8. In at least some embodiments, the support structure 902 further includes various sensors, such as one or more front-facing cameras, rear-facing cameras, other light sensors, motion sensors, accelerometers, and the like. The support structure 902 further can include one or more radio frequency (RF) interfaces or other wireless interfaces, such as a Bluetooth™ interface, a Wireless Fidelity (WiFi) interface, and the like.

Further, in at least some embodiments, the support structure 902 includes one or more batteries or other portable power sources for supplying power to the electrical components of the display system 900. In at least some embodiments, some or all of these components of the display system 900 are fully or partially contained within an inner volume of support structure 902, such as within the arm 904 in region 912 of the support structure 902. It should be noted that while an example form factor is depicted, it will be appreciated that in other embodiments, the display system 900 may have a different shape and appearance from the eyeglasses frame depicted in FIG. 9.

One or both of the lens elements 908, 910 are used by the display system 900 to provide an augmented reality (AR) or a mixed reality (MR) display in which rendered graphical content is superimposed over or otherwise provided in conjunction with a real-world view as perceived by the user through the lens elements 908, 910. For example, laser light used to form a perceptible image or series of images may be projected by a laser projector of the display system 900 onto the eye of the user via a series of optical elements, such as a waveguide (e.g., waveguide 800) having gratings (e.g., grating 112, grating 802, or grating 806) formed at least partially in the corresponding lens element, one or more scan mirrors, and one or more optical relays. Thus, one or both of the lens elements 908, 910 include at least a portion of a waveguide that routes display light received by an input grating (e.g., an input coupler), or multiple input couplers, of the waveguide to an output grating (e.g., an output coupler) of the waveguide, which outputs the display light toward an eye of a user of the display system 900. In at least some embodiments, the waveguide includes additional gratings, such as an exit-pupil-expander. The display light is modulated and scanned onto the eye of the user such that the user perceives the display light as an image. In addition, each of the lens elements 908, 910 is sufficiently transparent to allow a user to see through the lens elements to provide a field of view of the user's real-world environment such that the image appears superimposed over at least a portion of the real-world environment.

In at least some embodiments, the projector is a matrix-based projector, a digital light processing-based projector, a scanning laser projector, or any combination of a modulative light source such as a laser or one or more light-emitting diodes (LEDs) and a dynamic reflector mechanism such as one or more dynamic scanners or digital light processors. The projector, in at least some embodiments, includes multiple laser diodes (e.g., a red laser diode, a green laser diode, and a blue laser diode) and at least one scan mirror (e.g., two one-dimensional scan mirrors, which may be micro-electromechanical system (MEMS)-based or piezo-based). The projector is communicatively coupled to the controller and a non-transitory processor-readable storage medium or memory storing processor-executable instructions and other data that, when executed by the controller, cause the controller to control the operation of the projector. In at least some embodiments, the controller controls a scan area size and scan area location for the projector and is communicatively coupled to a processor (not shown) that generates content to be displayed at the display system 900. The projector scans light over a variable area, designated the FOV area 906, of the display system 900. The scan area size corresponds to the size of the FOV area 906, and the scan area location corresponds to a region of one of the lens elements 908, 910 at which the FOV area 906 is visible to the user. Generally, it is desirable for a display to have a wide FOV to accommodate the outcoupling of light across a wide range of angles. Herein, the range of different user eye positions that will be able to see the display is referred to as the eyebox of the display.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A computer-implemented method, in a processing device of an Optical Critical Dimension (OCD) metrology system, comprising:
receiving grating parameters as input to a neural network;
generating, by the neural network, an output comprising a predicted optical response of a grating based on the grating parameters;
responsive to determining that a difference between the predicted optical response and a measured optical response of the grating is within a specified threshold, outputting the grating parameters as a predicted structure of the grating; and
responsive to determining that the difference is greater than the specified threshold, iteratively updating the grating parameters received as input to the neural network until the predicted optical response and the measured optical response converge.

2. The computer-implemented method of claim 1, further comprising:
responsive to determining that the predicted structure of the grating deviates from a design specification for the grating by more than a specified threshold, failing the grating; and
responsive to determining that the predicted structure of the grating is within a specified threshold of the design specification for the grating, passing the grating.

3. The computer-implemented method of claim 1, further comprising:
responsive to determining that the predicted structure of the grating deviates from a design specification for the grating by more than a specified threshold, updating one or more fabrication parameters associated with the grating.

4. The computer-implemented method of claim 1, wherein each iteration of the iteratively updating the grating parameters comprises:
computing a loss value by applying a loss function to the predicted optical response and the measured optical response using a loss function;
performing a backpropagation process to compute a gradient of the loss function for each of the grating parameters based on the loss value; and
adjusting a value of each of the grating parameters to reduce the loss value by subtracting a fraction of the gradient calculated for the grating parameter, wherein adjusting the value of each of the grating parameters generates updated grating parameters.

5. The computer-implemented method of claim 4, further comprising:
receiving the updated grating parameters as input to the neural network;
generating, by the neural network, an output comprising a different predicted optical response of the grating based on the updated grating parameters;
responsive to determining that the different predicted optical response and the measured optical response of the grating converge, outputting the updated grating parameters as the predicted structure of the grating; and
responsive to determining that the different predicted optical response and the measured optical response of the grating do not converge, performing backpropagation and an optimization process to further update the grating parameters.

6. The computer-implemented method of claim 1, further comprising:
computing an uncertainty measure for one or more parameters of the predicted structure of the grating; and
outputting the uncertainty measure with the predicted structure of the grating.

7. The computer-implemented method of claim 1, wherein the predicted structure of the grating comprises one or more of grating period pitch, grating width, grating height or depth, grating sidewall angle, grating shape, or grating material properties.

8. The computer-implemented method of claim 1, wherein the predicted optical response includes one or more of ellipsometric data or Mueller matrices.

9. The computer-implemented method of claim 1, further comprising:
selecting a neural network architectural configuration from a plurality of neural network architectural configurations based on one or more aspects of the grating; and
implementing the neural network based on the selected neural network architectural configuration.

10. The computer-implemented method of claim 1, further comprising:
obtaining optical response data for a plurality of grating constructional parameters and a plurality of illumination conditions; and
training the neural network such that the neural network learns how to map each of the grating constructional parameters of the plurality of grating constructional parameters and each illumination condition of the plurality of illumination conditions to the optical response data.

11. A processing device comprising:
a processor; and
a prediction module implemented at the processor, the prediction module implementing a neural network and configured by the processor to:
receive grating parameters as input;
generate an output comprising a predicted optical response of a grating based on the grating parameters;
responsive to a determination that a difference between the predicted optical response and a measured optical response of the grating is within a specified threshold, output the grating parameters as a predicted structure of the grating; and
responsive to a determination that the difference is greater than the specified threshold, iteratively update the grating parameters received as input to the neural network until the predicted optical response and the measured optical response converge.

12. The processing device of claim 11, wherein the prediction module is further configured by the processor to:
responsive to a determination that the predicted structure of the grating deviates from a design specification for the grating by more than a specified threshold, fail the grating; and
responsive to a determination that the predicted structure of the grating is within a specified threshold of the design specification for the grating, pass the grating.

13. The processing device of claim 11, wherein the prediction module is further configured by the processor to:
responsive to a determination that the predicted structure of the grating deviates from a design specification for the grating by more than a specified threshold, update one or more fabrication parameters associated with the grating.

14. The processing device of claim 11, wherein the prediction module is configured by the processor to iteratively update the grating parameters at each iteration by:
computing a loss value by applying a loss function to the predicted optical response and the measured optical response using a loss function;
performing a backpropagation process to compute a gradient of the loss function for each of the grating parameters based on the loss value; and
adjusting a value of each of the grating parameters to reduce the loss value by subtracting a fraction of the gradient calculated for the grating parameter, wherein adjusting the value of each of the grating parameters generates updated grating parameters.

15. The processing device of claim 14, wherein the prediction module is further configured by the processor to:
receive the updated grating parameters as input to the neural network;
generate an output comprising a different predicted optical response of the grating based on the updated grating parameters;
responsive to a determination that the different predicted optical response and the measured optical response of the grating converge, output the updated grating parameters as the predicted structure of the grating; and
responsive to a determination that the different predicted optical response and the measured optical response of the grating do not converge, perform backpropagation and an optimization process to further update the grating parameters.

16. The processing device of claim 11, wherein the predicted structure of the grating comprises one or more of grating period pitch, grating width, grating height or depth, grating sidewall angle, grating shape, or grating material properties.

17. The processing device of claim 11, wherein the predicted optical response includes one or more of ellipsometric data or Mueller matrices.

18. The processing device of claim 11, wherein the prediction module is further configured by the processor to:
select a neural network architectural configuration from a plurality of neural network architectural configurations based on one or more aspects of the grating; and
implement the neural network based on the selected neural network architectural configuration.

19. The processing device of claim 11, further comprising a training module, wherein the training module is configured by the processor to:
obtain optical response data for a plurality of grating constructional parameters and a plurality of illumination conditions; and
train the neural network such that the neural network learns how to map each of the grating constructional parameters of the plurality of grating constructional parameters and each illumination condition of the plurality of illumination conditions to the optical response data.

20. A near-eye display system comprising:
an image source to project light comprising an image;
at least one lens element; and
a waveguide including at least one grating having a structure verified by a process comprising:
receiving grating parameters as input to a neural network;
generating, by the neural network, an output comprising a predicted optical response of a grating based on the grating parameters;
responsive to determining that a difference between the predicted optical response and a measured optical response of the grating is within a specified threshold, outputting the grating parameters as a predicted structure of the grating; and
responsive to determining that the difference is greater than the specified threshold, iteratively updating the grating parameters received as input to the neural network until the predicted optical response and the measured optical response converge.
